(19) United States
(12) Patent Application Publication
(10) Pub. No.: US 2023/0143498 A1
(43) Pub. Date: May 11, 2023

(54) SLIDING CLAMP

(71) Applicants: Carl BJOERK, Greensboro, NC (US); Volvo Truck Corporation, Göteborg (SE)

(72) Inventor: Carl Bjoerk, Greensboro, NC (US)

(21) Appl. No.: 17/766,543

(22) PCT Filed: Oct. 29, 2019
(86) PCT No.: PCT/US2019/058471

§ 371 Date: Apr. 5, 2022

(51) Int. Cl. B25B 5/04; B25B 5/02; B25B 5/06; B25B 5/16

(52) U.S. Cl. CPC B25B 5/04; B25B 5/02; B25B 5/067; B25B 5/16

(57) ABSTRACT

Aspects of the disclosure relate to a sliding clamp including a first arm with a first jaw attached to the first arm, and a second arm with a second jaw attached thereto. The first jaw includes at least one first clamping ball freely rotatable relative to the first arm, and the second jaw includes at least one second clamping ball freely rotatable relative to the second arm. The second arm is configured to move relative to the first arm to adjust a jaw opening between the at least one second clamping ball of the second jaw and the at least one first clamping ball of the first jaw. The sliding clamp is configured to constrain a workpiece to a clamping plane while permitting translation of the workpiece within the clamping plane.

### FIELD OF THE DISCLOSURE

The disclosure relates generally to clamps. In particular aspects, the disclosure relates to a sliding clamp that constrains a workpiece to a clamping plane while permitting translation of the workpiece within the clamping plane.

### BACKGROUND

Clamps are often used to lock relative movement between two workpieces. In particular, clamps typically lock relative movement in all directions.

In certain applications, it may be desirable to lock relative movement in one direction while allowing relative movement in other directions. For example, in a welding fixture (e.g., for body in white (BIW) stage in vehicle manufacture), a workpiece may need to move after being clamped to assured a desired geometry with another workpiece before proceeding with welding.

### SUMMARY

According to an aspect of the disclosure, a sliding clamp includes a first arm, a first jaw attached to the first arm, a second arm, and a second jaw attached to the second arm. The first jaw includes at least one first clamping ball freely rotatable relative to the first arm. The second jaw includes at least one second clamping ball freely rotatable relative to the second arm. The second arm is configured to move relative to the first arm to adjust a jaw opening between the at least one second clamping ball of the second jaw and the at least one first clamping ball of the first jaw.

In certain embodiments, in a clamped orientation, the sliding clamp is configured to constrain translation of a workpiece in one translational direction by clamping pressure applied to the workpiece by the at least one first clamping ball and the at least one second clamping ball, and permit translation of the workpiece in two translational directions by rotation of the at least one first clamping ball and the at least one second clamping ball.

In certain embodiments, the at least one first clamping ball is configured to freely rotate about three mutually perpendicular axes.

In certain embodiments, the at least one first clamping ball includes a plurality of first clamping balls.

In certain embodiments, the first jaw includes a first set of ball bearings positioned between the first arm and the at least one first clamping ball.

In certain embodiments, the first jaw is removably attached to the first arm.

In certain embodiments, the first jaw includes a first shell attached to the first arm, the at least one first clamping ball positioned in the first shell.

In certain embodiments, the first shell includes a first base and a first endcap attached to the first base.

In certain embodiments, the first base is attached to the first arm by at least one of adhesion, threading, or rivets.

In certain embodiments, the first end cap defines a first aperture having a width of less than a diameter of the clamping ball. At least a portion of the at least one first clamping ball protrudes through the first aperture.

In certain embodiments, the first jaw includes a first set of ball bearings positioned within the first shell.

In certain embodiments, the first arm includes a first concave surface defining a first cavity, at least a portion of the at least one first clamping ball positioned in the first cavity.

In certain embodiments, the sliding clamp includes at least one of a c-clamp, f-clamp, or spring clamp.

In certain embodiments, the first arm is connected to the second arm by at least one of a hinge, a thread, or a slide.

In certain embodiments, the sliding clamp further includes a spring to bias the second jaw toward the first jaw.

In certain embodiments, the sliding clamp further includes a lock to selectively prevent relative movement of the second jaw relative to the first jaw.

According to an aspect of the disclosure, a method of making a sliding clamp includes attaching a first jaw to a first arm, the first jaw including at least one first clamping ball freely rotatable relative to the first arm. The method further includes attaching a second jaw at a second arm, the second jaw including at least one second clamping ball freely rotatable relative to the second arm. The method further includes attaching the first arm to the second arm such that the second arm is moveable relative to the first arm to adjust a jaw opening between the at least one second clamping ball of the second jaw and the at least one first clamping ball of the first jaw.

In certain embodiments, in a clamped orientation, the sliding clamp is configured to constrain translation of a workpiece in one translational direction by clamping pressure applied to the workpiece by the at least one first clamping ball and the at least one second clamping ball, and permit translation of the workpiece in two translational directions by rotation of the at least one first clamping ball and the at least one second clamping ball.

In certain embodiments, the first jaw is removably attached to the first arm.

In certain embodiments, the sliding clamp further includes forming the first jaw by positioning the at least one first clamping ball within a first shell.

In certain embodiments, the sliding clamp further includes forming the first jaw by positioning the at least one first clamping ball and a first set of ball bearings within the first shell.

Additional features and advantages will be set forth in the detailed description which follows, and in part will be readily apparent from that description to those skilled in the art or recognized by practicing the embodiments as described herein, including the detailed description which follows, the claims, as well as the appended drawings.

It is to be understood that both the foregoing general description and the following detailed description are merely exemplary, and are intended to provide an overview or framework for understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1A is a perspective view of a sliding clamp of the present disclosure;

FIG. 1B is a cross-sectional side view of the sliding clamp of FIG. 1A;

FIG. 1C is a close up perspective view of a first jaw and a second jaw of the sliding clamp of FIG. 1A;

FIG. 1D is a close up cross-sectional side view of the first jaw and the second jaw of the sliding clamp of FIG. 1A;

FIG. 2A is a cross-sectional side view of the sliding clamp of FIGS. 1A-1D with a first arm and a second arm in an unclamped orientation and a workpiece positioned therebetween;

FIG. 2B is a cross-sectional side view of the sliding clamp of FIG. 2A with the first arm and the second arm in a clamped orientation and the workpiece in an initial clamped position;

FIG. 2C is a cross-sectional side view of the sliding clamp of FIG. 2A with the first arm and the second arm in a clamped orientation and the workpiece in a translated clamped position;

FIG. 3A is a perspective view of a plurality of sliding clamps of FIGS. 1A-2C in a clamped orientation with a workpiece in an initial clamped position in a first direction and a second direction;

FIG. 3B is a perspective view of the plurality of sliding clamps of FIG. 3A in a clamped orientation with the workpiece in a translated clamped position in the first direction and the initial clamped position in the second direction;

FIG. 3C is a perspective view of the plurality of sliding clamps of FIG. 3A in a clamped orientation with the workpiece in the translated clamped position in the first direction and the second direction;

FIG. 4 is a perspective view of a sliding C-clamp;

FIG. 5 is a perspective view of a sliding F-clamp; and

FIG. 6 is a flowchart illustrating a method of making a sliding clamp of FIGS. 1A-5.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

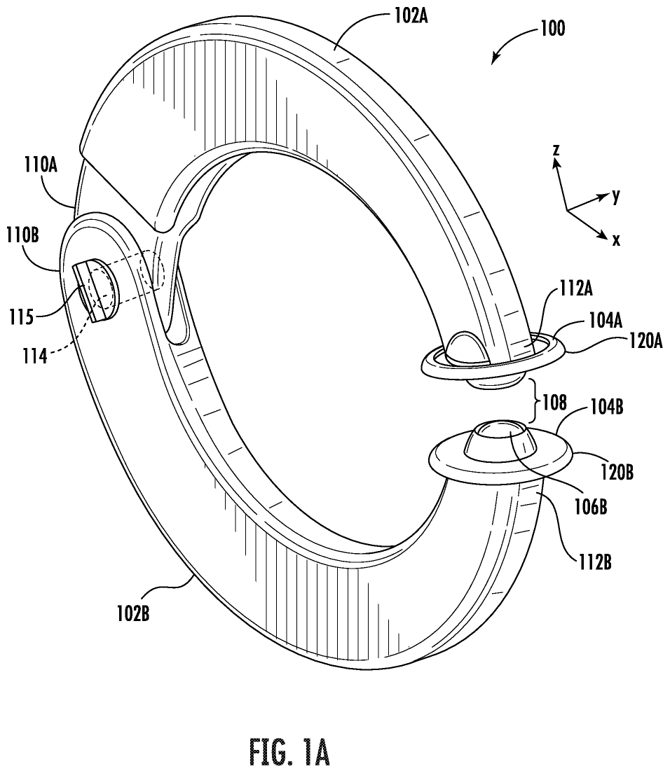

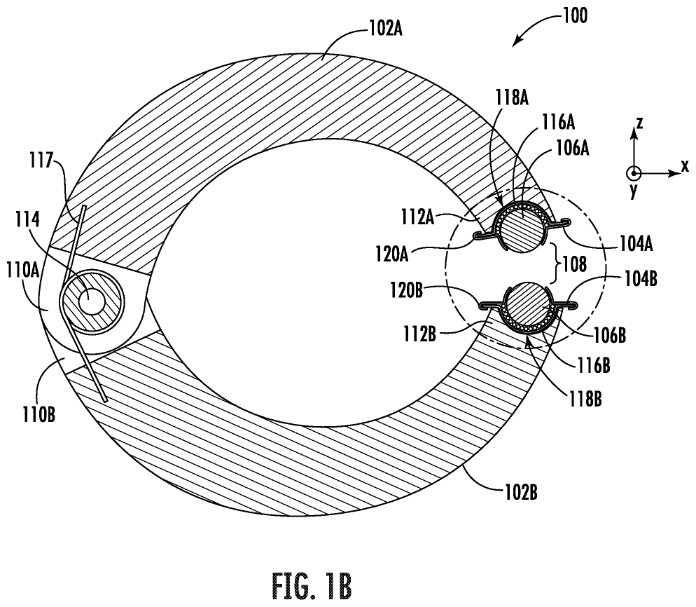

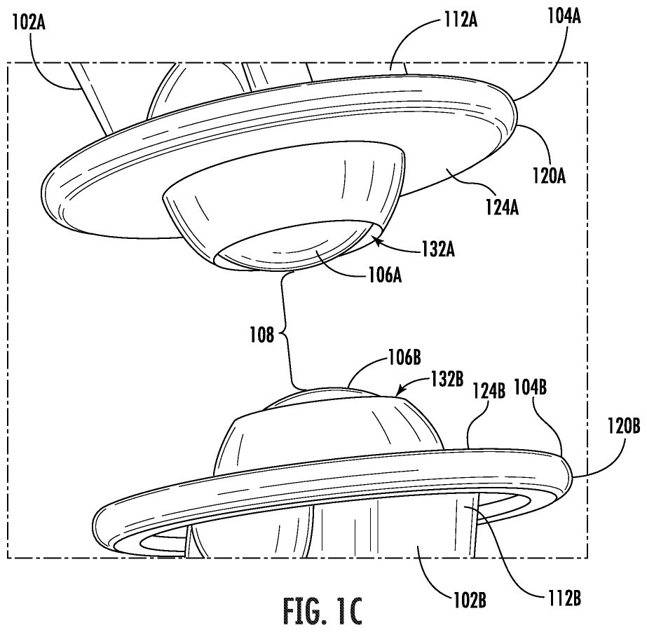

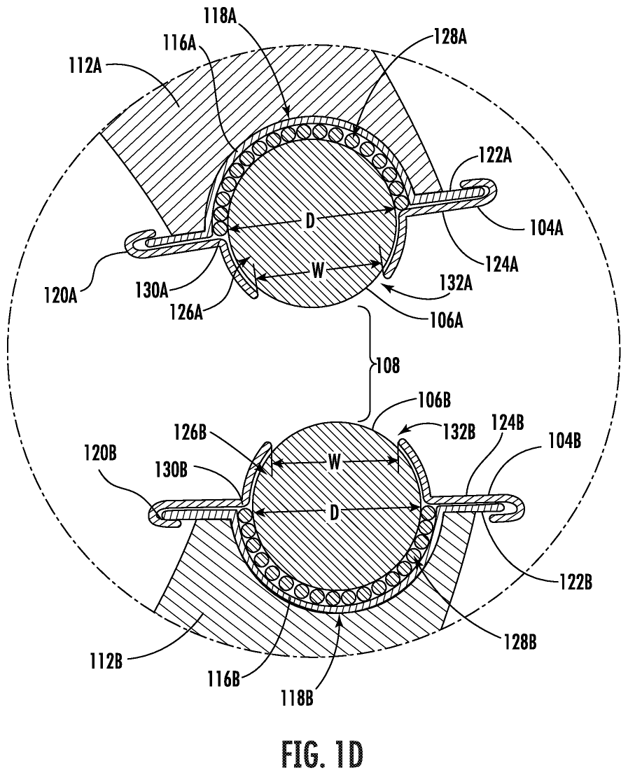

FIGS. 1A-1D are views of a sliding clamp 100 including a first arm 102A, a first jaw 104A attached to the first arm 102A, a second arm 102B movably attached to the first arm 102A, and a second jaw 104B attached to the second arm 102B. The first jaw 104A includes at least one first clamping ball 106A freely rotatable relative to the first arm 102A, and the second jaw 104B includes at least one second clamping ball 106B freely rotatable relative to the second arm 102B. The second arm 102B is configured to move relative to the first arm 102A to adjust a jaw opening 108 between the at least one second clamping ball 106B of the second jaw 104B and the at least one first clamping ball 106A of the first jaw 104A. The sliding clamp 100 is configured to constrain a workpiece to a clamping plane while permitting translation of the workpiece within the clamping plane. In other words, the sliding clamp 100 is configured to constrain translation of a workpiece in one translational direction along a first perpendicular axis (e.g., z axis) by clamping pressure applied to the workpiece by the at least one first clamping ball 106A and the at least one second clamping ball 106B. The sliding clamp 100 is further configured, in a clamped orientation, to permit translation of the workpiece in two translational directions along a second perpendicular axis (e.g., x axis) and/or a third perpendicular axis (e.g., y axis) by rotation of the at least one first clamping ball 106A and the at least one second clamping ball 106B, the first perpendicular axis, the second perpendicular axis, and the third perpendicular axis being mutually perpendicular axes.

Referring to FIGS. 1A and 1B, in the illustrated embodiment, the first arm 102A includes a coupling end 110A (may also be referred to as a first coupling end, etc.) and a clamping end 112A (may also be referred to as a first clamping end, etc.) opposite the coupling end 110A. The first arm 102A is arcuately shaped (i.e., curved) with the first jaw 104A at the clamping end 112A of the first arm 102A. Similarly, the second arm 102B includes a coupling end 110B (may also be referred to as a second coupling end, etc.) and a clamping end 112B (may also be referred to as a second clamping end, etc.) opposite the coupling end 110B. The second arm 102B is arcuately shaped (i.e., curved) with the second jaw 104B at the clamping end 112B of the second arm 102B. Although the first arm 102A and the second arm 102B are illustrated as arcuately shaped, other shapes may be used.

The coupling end 110A of the first arm 102A is mechanically and movably coupled to the coupling end 110B of the second arm 102B to allow relative movement between the first jaw 104A at the clamping end 112A and the second jaw 104B at the clamping end 112B, such as by pivoting, sliding, rotating, etc. The second arm 104B is configured to move relative to the first arm 104A to adjust a jaw opening 108 (e.g., increase or decrease) between the at least one second clamping ball 106B of the second jaw 104B and the at least one first clamping ball 106A of the first jaw 104A.

In this embodiment, the first arm 102A is hingedly connected to the second arm 102B at a hinge connection 114. Although a hinge connection 114 is shown, other types of connections could be used, such as a threaded connection, a slide connection, etc. The sliding clamp 100 includes a locking mechanism 115 (see FIG. 1A) and/or biasing mechanism 117 (see FIG. 1B). For example, in certain embodiments, the sliding clamp 100 is a spring clamp and the biasing mechanism 117 includes a spring (e.g., within the hinge connection) to bias the second jaw 104B toward the first jaw 104A. In certain embodiments, the sliding clamp 100 is a locking clamp and the locking mechanism 115 includes a friction lock (e.g., within the hinge connection) to selectively prevent (e.g., lock and unlock) relative to movement of the second jaw 104B to the first jaw 104A. For example, turning the friction lock in one direction increases the pressure between the first arm 102A and the second arm 102B to inhibit relative motion therebetween, while turning the friction lock in the other direction decreases the pressure between the first arm 102A and the second arm 102B.

Referring to FIG. 1B, the first jaw 104A includes at least one first clamping ball 106A freely rotatable relative to the first arm 102A to thereby permit translation of a workpiece. The first arm 102A includes a first concave surface 116A defining a first cavity 118A with at least a portion of the first clamping ball 106A positioned in the first cavity 118A. More particularly, the first jaw 104A includes a first shell 120A attached to the first arm 102A. The at least one first clamping ball 106A is positioned in the first shell 120A and the at least one first clamping ball 106A is configured to freely rotate within the first shell 120A about three mutually perpendicular axes (e.g., x axis, y axis, and z axis) to constrain the workpiece to a clamping plane and permit translation of the workpiece within the clamping plane.

Similarly, the second jaw 104B includes at least one second clamping ball 106B freely rotatable relative to the second arm 102B to thereby permit translation of the workpiece. The second arm 102B includes a second concave surface 116B defining a second cavity 118B with at least a portion of the second clamping ball 106B positioned in the second cavity 118B. More particularly, the second jaw 104B includes a second shell 120B attached to the second arm 102B. The at least one second clamping ball 106B is positioned in the second shell 120B and the at least one second clamping ball 106B is configured to freely rotate within the second shell 120B about three mutually perpendicular axes (e.g., x axis, y axis, and z axis) to constrain the workpiece to the clamping plane and permit translation of the workpiece within the clamping plane.

In certain embodiments, different jaws 104A, 104B may be needed for different applications. For example, certain applications and/or workpieces may require clamping balls 106A, 106B of a differing size and/or hardness, etc. Accordingly, in certain embodiments, the first jaw 104A is removably attached to the first arm 102A and the second jaw 104B is removably attached to the second arm 102B. Exemplary removable attachments include threading, rivets, magnets, etc. In this way, the sliding clamp 100 includes a plurality of different types of jaws 104A, 104B with different types of clamping balls 106A, 106B that are interchangeable depending on the application.

Referring to FIGS. 1C and 1D, in certain embodiments, the first shell 120A of the first jaw 104A includes a first base 122A and a first endcap 124A attached to the first base 122A such as by bending and/or wrapping a portion of the first endcap 124A around a portion of the first base 122A. The first base 122A is attached (e.g., removably attached or permanently attached) to the first arm 102A, such as by adhesion, welding, threading, and/or rivets. The first base 122A and the first endcap 124A define a first interior 126A therebetween with the first clamping ball 106A positioned in and freely movable within the first interior 126A. In particular, in certain embodiments, the at least one first jaw 104A includes a first set of ball bearings 128A positioned within the first shell 120A and/or between the first arm 102A and the at least one first clamping ball 106A. The first set of ball bearings 128A minimizes frictional forces applied to the first clamping ball 106A, particularly in a clamped orientation. This reduces the force necessary to translate a clamped workpiece when the sliding clamp 100 is in a clamped orientation. The first set of ball bearings 128A is retained within the first shell 120A between the first clamping ball 106A and the first base 122A (and the first arm 102A) by an endcap shoulder 130A.

The first end cap 124A defines a first aperture 132A so that at least a portion of the first clamping ball 106A protrudes through the first aperture 132A to contact the workpiece. The first aperture 132A has a width W of less than a diameter D of the first clamping ball 106A to retain the first clamping ball 106A within the first shell 120A while allowing first the clamping ball 106A to contact the workpiece.

In certain embodiments, the second shell 120B of the second jaw 104B includes a second base 122B and a second endcap 124B attached to the second base 122B such as by bending and/or wrapping a portion of the second endcap 124B around a portion of the second base 122B. The second base 122B is attached to the second arm 102B, such as by adhesion, welding, threading, and/or rivets. The second base 122B and the second endcap 124B define a second interior 126B therebetween with the second clamping ball 106B positioned in and freely movable within the second interior 126B. In particular, in certain embodiments, the at least one second jaw 104B includes a second set of ball bearings 128B positioned within the second shell 120B and/or between the second arm 102B and the at least one second clamping ball 106B. The second set of ball bearings 128B minimizes frictional forces applied to the second clamping ball 106B, particularly in a clamped orientation. This reduces the force necessary to translate a clamped workpiece when the sliding clamp 100 is in a clamped orientation. The second set of ball bearings 128B is retained within the second shell 120B between the second clamping ball 106B and the second base 122B (and the second arm 102B) by an endcap shoulder 130B.

The second end cap 124B defines a second aperture 132B so that at least a portion of the second clamping ball 106B protrudes through the second aperture 132B to contact the workpiece. The second aperture 132B has a width W of less than a diameter D of the second clamping ball 106B to retain the second clamping ball 106B within the second shell 120B while allowing the second clamping ball 106B to contact the workpiece.

The first jaw 104A and the second jaw 104B each include single clamping balls 106A, 106B which is advantageous for minimizing the contact area of the clamping balls 106A, 106B with the workpiece, thereby allowing greater precision. However, in certain embodiments, the at least one first clamping ball 106A includes a plurality of first clamping balls and/or the first endcap 124A includes a plurality of apertures. Similarly, in certain embodiments, the at least one second clamping ball 106B includes a plurality of second clamping balls and/or the second endcap 124B includes a plurality of apertures. Doing so may distribute the pressure and/or compressive force applied to the workpiece.

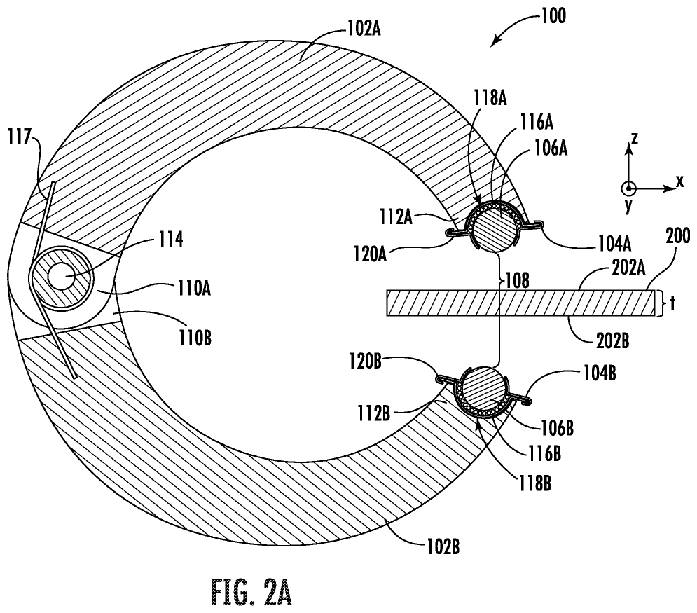

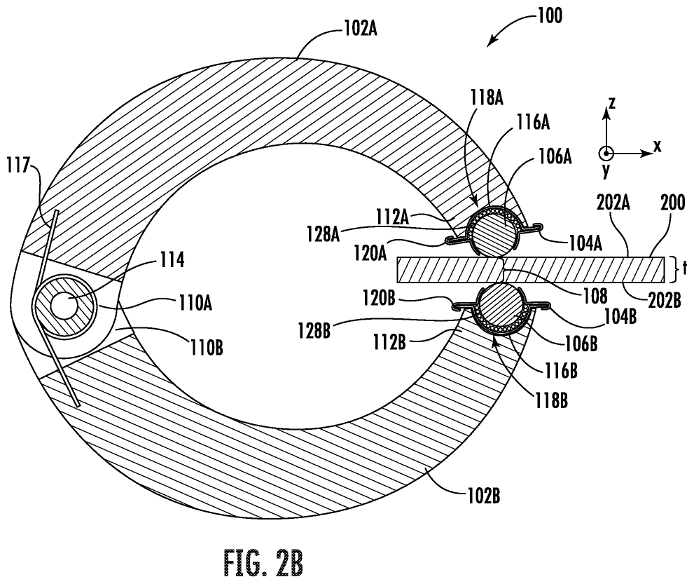

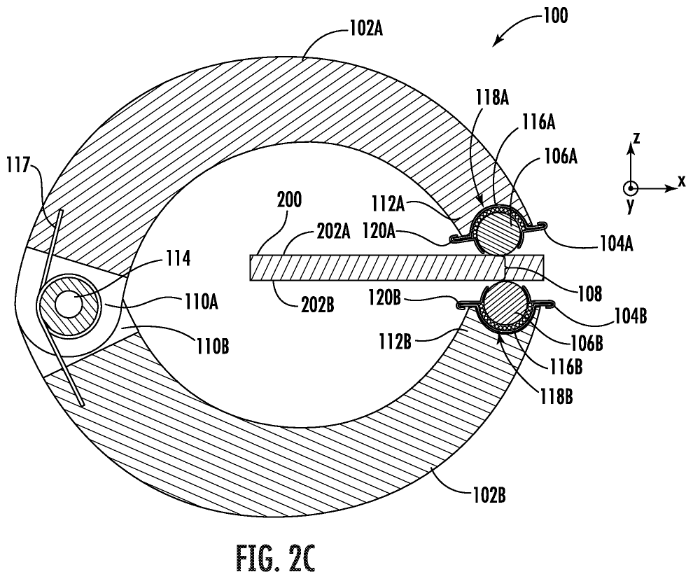

FIGS. 2A-2C are views of the sliding clamp 100 in an unclamped orientation and a clamped orientation. In particular, FIG. 2A is a cross-sectional side view of the sliding clamp 100 with a first arm 102A and a second arm 102B in an unclamped orientation and a workpiece 200 positioned therebetween. The workpiece 200 includes a first surface 202A and a second surface 202B opposite thereto. Although one workpiece 200 is shown and described, it is noted that the sliding clamp 100 could be used to clamp and constrain two workpieces 200 relative to each other. The jaw opening 108 is wider than a thickness t of the workpiece 200 with the workpiece 200 positioned in the jaw opening 108 between the first clamping ball 106A of the first jaw 104A and the second clamping ball 106B of the second jaw 104B. The first clamping ball 106A and the second clamping ball 106B do not contact the workpiece 200 in FIG. 2A.

FIG. 2B is a cross-sectional side view of the sliding clamp 100 of FIG. 2A with the first arm 102A and the second arm 102B in a clamped orientation and the workpiece 200 in an initial clamped position (may also be referred to as first translational position). The jaw opening 108 is the same (or substantially the same) as the thickness t of the workpiece 200 with the workpiece 200 positioned in the jaw opening 108 between the first clamping ball 106A of the first jaw 104A and the second clamping ball 106B of the second jaw 104B. The first clamping ball 106A contacts the first surface 202A of the workpiece 200 and the second clamping ball 106B contacts the second surface 202B of the workpiece 200. In a clamped orientation, the sliding clamp 100 constrains translation of the workpiece 200 in the z direction by clamping pressure applied to the workpiece 200 by the first clamping ball 106A and the second clamping ball 106B.

FIG. 2C is a cross-sectional side view of the sliding clamp of FIG. 2A with the first arm 102A and the second arm 102B in a clamped orientation and the workpiece 200 in a translated clamped position (may also be referred to as a second translational position). The sliding clamp 100 permits translation of the workpiece 200 in two translational directions (e.g., x direction and y direction) by rotation of the at least one first clamping ball 106A (and associated first set of ball bearings 128A) and the at least one second clamping ball 106B (and associated second set of ball bearings 128B). In particular, for example, the workpiece 200 translates along the x axis by rotation of the first clamping ball 106A (and associated first set of ball bearings 128A) and the second clamping ball 106B (and associated second set of ball bearings 128B). In this way, the first clamping ball 106A and second clamping ball 106B rotate in opposite directions. The workpiece 200 is thus able to translate to a translated clamped position.

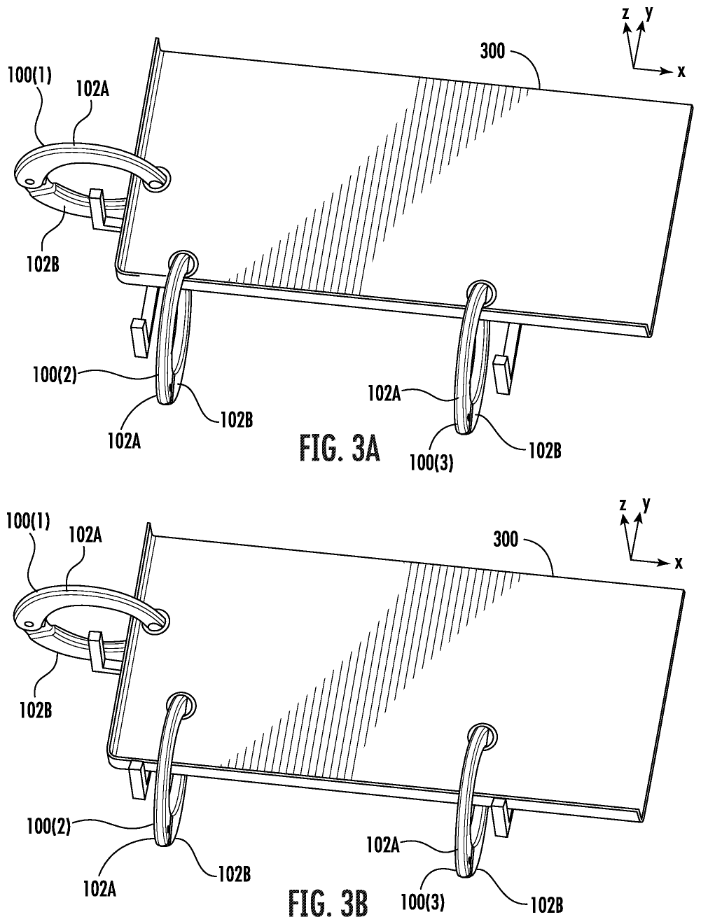

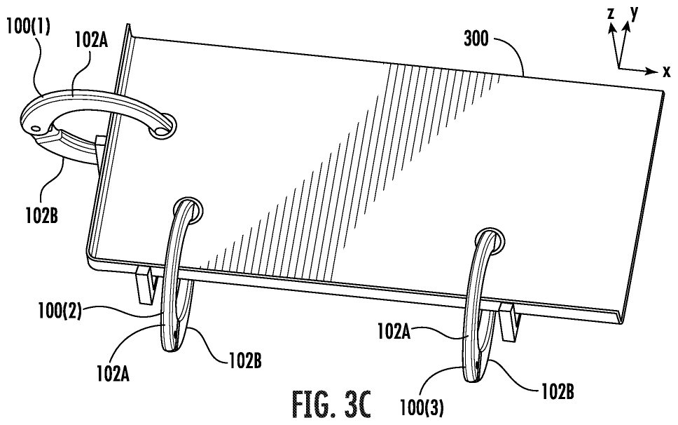

FIGS. 3A-3C are views of a plurality of sliding clamps 100(1)-100(3) in a clamped orientation with a workpiece 300 in an initial clamped position and a translated clamped position. Referring to FIG. 3A, the plurality of sliding clamps 100(1)-100(3) clamp the workpiece 300 in an initial position, thereby constraining the workpiece 300 within a clamping plane (e.g., x-y plane) in a z direction. Referring to FIG. 3B, while the workpiece 300 is clamped, the workpiece 300 is translated within the clamping plane (e.g., x-y plane) in a y direction to a first translated clamped position. Referring to FIG. 3C, while the workpiece 300 is clamped, the workpiece 300 is translated within the clamping plane (e.g., x-y plane) in an x direction to a second translated clamped position. Translation of the workpiece 300 while clamped is made possible by the first clamping ball 106A and the second clamping ball 106B.

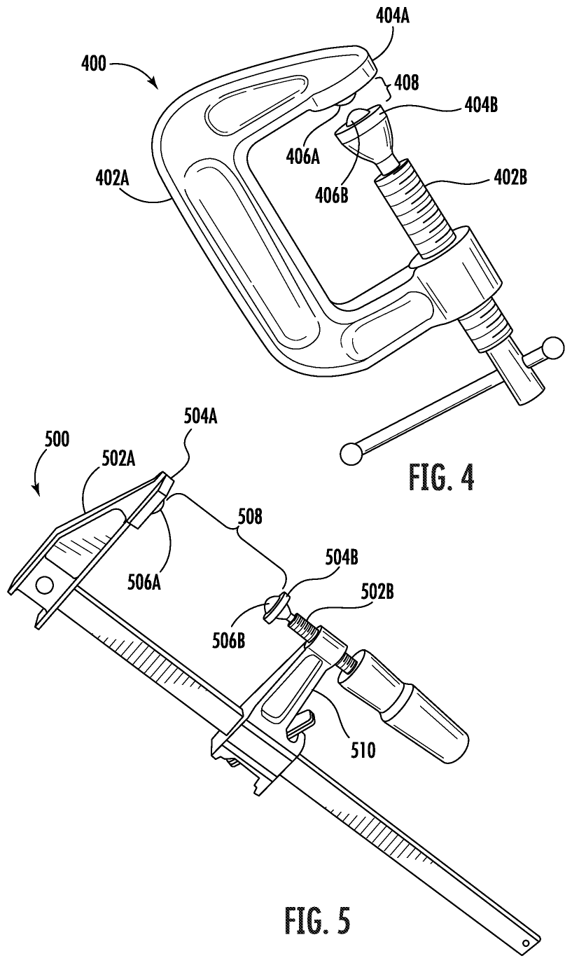

FIGS. 1A-3C illustrate one type of clamp, however, other types of clamps may be used. For example, FIG. 4 is a perspective view of a sliding C-clamp 400. The sliding C-clamp 400 works and operates similarly to the sliding clamp 100 of FIGS. 1A-3C except where otherwise noted. The sliding C-clamp 400 includes a first arm 402A, a first jaw 404A attached to the first arm 402A, a second arm 402B movably attached to the first arm 402A, and a second jaw 404B attached to the second arm 402B. The first jaw 404A includes at least one first clamping ball 406A freely rotatable relative to the first arm 402A, and the second jaw 404B includes at least one second clamping ball 406B freely rotatable relative to the second arm 402B. A distance between the first clamping ball 406A and the second clamping ball 406B defines a jaw opening 408. The first arm 402A is threadably coupled to the second arm 402B such that rotation of the second arm 402B adjusts the size of the jaw opening 408.

As another example, FIG. 5 is a perspective view of a sliding F-clamp 500. The sliding F-clamp 500 works and operates similarly to the sliding clamp 100 of FIGS. 1A-3C except where otherwise noted. The sliding F-clamp 500 includes a first arm 502A, a first jaw 504A attached to the first arm 502A, a second arm 502B movably attached to the first arm 502A, and a second jaw 504B attached to the second arm 502B. The first jaw 504A includes at least one first clamping ball 506A freely rotatable relative to the first arm 502A, and the second jaw 504B includes at least one second clamping ball 506B freely rotatable relative to the second arm 502B. A distance between the first clamping ball 506A and the second clamping ball 506B defining a jaw opening 508. The sliding F-clamp 500 further includes an intermediate arm 510. The intermediate arm 510 is slidably attached to the first arm 502A and threadably attached to the second arm 502B. Sliding movement of the intermediate arm 510 relative to the first arm 502A and/or rotation of the second arm 502B relative to the intermediate arm 510 adjusts the size of the jaw opening 508.

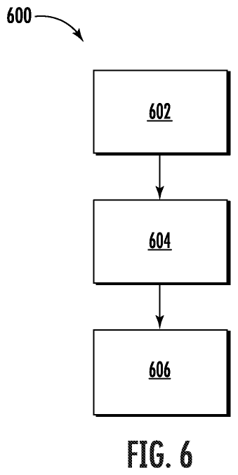

FIG. 6 is a flowchart 600 illustrating a method of making a sliding clamp 100, 400, 500 of FIGS. 1A-5. Step 602 includes attaching a first jaw 104A, 404A, 504A to a first arm 102A, 402A, 502A. The first jaw 104A, 404A, 504A includes at least one first clamping ball 106A, 406A, 506A freely rotatable relative to the first arm 102A, 402A, 502A. Step 604 includes attaching a second jaw 104B, 404B, 504B at a second arm 102B, 402B, 502B. The second jaw 104B, 404B, 504B includes at least one second clamping ball 106B, 406B, 506B freely rotatable relative to the second arm 102B, 402B, 502B. Step 606 includes attaching the first arm 102A, 402A, 502A to the second arm 102B, 402B, 502B such that the second arm 102B, 402B, 502B is moveable relative to the first arm 102A, 402A, 502A to adjust a jaw opening 108, 408, 508 between the at least one second clamping ball 106B, 406B, 506B of the second jaw 104B, 404B, 504B and the at least one first clamping ball 106A, 406A, 506A of the first jaw 104A, 404A, 504A.

In certain embodiments, in a clamped orientation, the sliding clamp 100, 400, 500 is configured to constrain translation of a workpiece in one translational direction by clamping pressure applied to the workpiece by the at least one first clamping ball 106A, 406A, 506A and the at least one second clamping ball 106B, 406B, 506B, and permit translation of the workpiece in two translational directions by rotation of the at least one first clamping ball 106A, 406A, 506A and the at least one second clamping ball 106B, 406B, 506B. In certain embodiments, the first jaw 104A, 404A, 504A is removably attached to the first arm 102A, 402A, 502A and/or the second jaw 104B, 404B, 504B is removably attached to the second arm 102B, 402B, 502B.

In certain embodiments, the method further includes forming the first jaw 104A, 404A, 504A by positioning the at least one first clamping ball 106A, 406A, 506A within a first shell 120A. In certain embodiments, the method further includes forming the first jaw 104A, 404A, 504A by positioning the at least one first clamping ball 106A, 406A, 506A and a first set of ball bearings 128A within a first shell 120A. Similarly, in certain embodiments, the method further includes forming the second jaw 104B, 404B, 504B by positioning the at least one second clamping ball 106B, 406B, 506B within a second shell 120B. In certain embodiments, the method further includes forming the second jaw 104B, 404B, 504B by positioning the at least one second clamping ball 106B, 406B, 506B and a second set of ball bearings 128B within a second shell 120B.

Those skilled in the art will recognize improvements and modifications to the preferred embodiments of the present disclosure. All such improvements and modifications are considered within the scope of the concepts disclosed herein and the claims that follow.

What is claimed is:

1. A sliding clamp, comprising:
a first arm;
a first jaw attached to the first arm, the first jaw including at least one first clamping ball freely rotatable relative to the first arm;
a second arm mechanically connected to the first arm; and
a second jaw attached to the second arm, the second jaw including at least one second clamping ball freely rotatable relative to the second arm;
wherein the second arm is configured to move relative to the first arm to adjust a jaw opening between the at least one second clamping ball of the second jaw and the at least one first clamping ball of the first jaw; and
wherein, in a clamped orientation, the sliding clamp is configured to:
constrain translation of a workpiece in one translational direction by clamping pressure applied to the workpiece by the at least one first clamping ball and the at least one second clamping ball; and
permit translation of the workpiece in two translational directions by rotation of the at least one first clamping ball and the at least one second clamping ball.

2. (canceled)

3. The sliding clamp of claim 1, wherein the at least one first clamping ball is configured to freely rotate about three mutually perpendicular axes.

4. The sliding clamp of claim 1, wherein the at least one first clamping ball comprises a plurality of first clamping balls.

5. The sliding clamp of claim 1, wherein the first jaw includes a first set of ball bearings positioned between the first arm and the at least one first clamping ball.

6. The sliding clamp of claim 1, wherein the first jaw is removably attached to the first arm.

7. The sliding clamp of claim 1, wherein the first jaw comprises a first shell attached to the first arm, the at least one first clamping ball positioned in the first shell.

8. The sliding clamp of claim 7, wherein the first shell comprises a first base and a first endcap attached to the first base.

9. The sliding clamp of claim 8, wherein the first base is attached to the first arm by at least one of adhesion, threading, or rivets.

10. The sliding clamp of claim 8, the first end cap defining a first aperture having a width of less than a diameter of the clamping ball, at least a portion of the at least one first clamping ball protruding through the first aperture.

11. The sliding clamp of claim 7, wherein the first jaw includes a first set of ball bearings positioned within the first shell.

12. The sliding clamp of claim 1, wherein the first arm comprises a first concave surface defining a first cavity, at least a portion of the at least one first clamping ball positioned in the first cavity.

13. The sliding clamp of claim 1, wherein the sliding clamp comprises at least one of a c-clamp, f-clamp, or spring clamp.

14. The sliding clamp of claim 1, wherein the first jaw is mechanically connected to the second jaw by at least one of a hinge, a thread, or a slide.

15. The sliding clamp of claim 1, further comprising a spring to bias the second arm toward the first arm.

16. The sliding clamp of claim 1, further comprising a lock to selectively prevent relative movement of the second jaw relative to the first jaw.

17. A method of making a sliding clamp, comprising:
attaching a first jaw to a first arm, the first jaw including at least one first clamping ball freely rotatable relative to the first arm;
attaching a second jaw at a second arm, the second jaw including at least one second clamping ball freely rotatable relative to the second arm; and
attaching the first arm to the second arm such that the second arm is moveable relative to the first arm to adjust a jaw opening between the at least one second clamping ball of the second jaw and the at least one first clamping ball of the first jaw;
wherein, in a clamped orientation, the sliding clamp is configured to:
constrain translation of a workpiece in one translational direction by clamping pressure applied to the workpiece by the at least one first clamping ball and the at least one second clamping ball; and
permit translation of the workpiece in two translational directions by rotation of the at least one first clamping ball and the at least one second clamping ball.

18. (canceled)

19. The method of claim 17, wherein the first jaw is removably attached to the first arm.

20. The method of claim 17, further comprising forming the first jaw by positioning the at least one first clamping ball within a first shell.

21. The method of claim 20, further comprising forming the first jaw by positioning the at least one first clamping ball and a first set of ball bearings within the first shell.
